(19) United States
(12) Patent Application Publication
(10) Pub. No.: US 2025/0317283 A1
(43) Pub. Date: Oct. 9, 2025

(54) DEVICE AND METHOD FOR COMMUNICATION WITH A REMOTE DEVICE TO PERFORM INFORMATION RECONCILIATION IN A QUANTUM KEY DISTRIBUTION SYSTEM

(71) Applicant: Huawei Technologies Duesseldorf GmbH, Duesseldorf (DE)

(72) Inventor: Fred Chi Hang Fung, Munich (DE)

(21) Appl. No.: 19/244,395

(22) Filed: Jun. 20, 2025

Related U.S. Application Data
(63) Continuation of application No. PCT/EP2023/055676, filed on Mar. 7, 2023.

(30) Foreign Application Priority Data
Dec. 22, 2022 (DE) 102022004991.0

(51) Int. Cl. H04L 9/08

(52) U.S. Cl. CPC H04L 9/0858

(57) ABSTRACT

In accordance with an embodiment, a method includes: obtaining Quantum Key Distribution (QKD) data; dividing the QKD data into a set of data blocks, wherein each data block of the set of data blocks of the device corresponds to a data block of a remote device; determining, based on a Bit Error Rate (BER) or a Signal to Noise Ratio (SNR), an error correction code, where the error correction code is configured such that a code rate of the error correction code is larger than a Shannon capacity for noise exhibited by the QKD data, or that the error correction code, after decoding the QKD data, leaves errors in corrected QKD data with a probability of at least 98%; performing an error correction step; and performing an error detection step. The error correction step and the error detection step are performed in any order.

### CROSS-REFERENCE TO RELATED APPLICATIONS

This application is a continuation of International Application No. PCT/EP2023/055676, filed on Mar. 7, 2023, which claims priority to Germany Patent Application No. DE 102022004991.0, filed on Dec. 22, 2022, the disclosure of which is hereby incorporated by reference in its entirety.

### TECHNICAL FIELD

The present disclosure relates to the field of Quantum Key Distribution (QKD). The present disclosure provides a device and a method for performing information reconciliation in the QKD system. The disclosure also relates to a computer program to perform the method.

### BACKGROUND

QKD protocols are methods for generating secret keys based on quantum physics. The generated keys are information-theoretically secure, in contrast to computational security offered by conventional cryptographic methods.

There are two main types of QKD protocols adopted in practical QKD systems: discrete-variable (DV) based and continuous-variable (CV) based. In DV-QKD, the secure bits are derived from information carried in single photons. In CV-QKD, the secure bits are derived from information carried in the quadratures of the quantized electromagnetic wave. DV-QKD and CV-QKD systems rely on different detection technologies for implementation.

DV-QKD has the disadvantages of requiring specialized single-photon detectors (as opposed to telecom detectors used in CV-QKD) and a separate synchronization channel, which may occupy a different wavelength or a different fiber, while DV-QKD may achieve longer distances.

An error correction code is characterized by a code rate, which is the ratio between the information length and the codeword length. In conventional protocols, a larger code rate is preferable (assuming all the other parameters involved in the QKD protocol remain unchanged), as this means that more information is carried by using the same amount of communication resource.

An error correction code is also characterized by a threshold error correction capability, such as the Bit Error Rate (BER) or Signal to Noise Ratio (SNR). QKD data containing noise at a level beyond the threshold (i.e. more noise) is generally considered not correctable by the error correction code.

In many modern error correction schemes, the threshold error correction capability is associated with a failure probability, which is normally negligible. When the data presented to a decoder contains less noise than what the scheme is capable of correcting, the decoding succeeds and corrects all the errors with a high probability. The Shannon capacity theorem asserts a relation between a certain noise distribution in the QKD data and the best code rate for any error correction code to remove the noise in an asymptotic limit of infinite-length codes.

That is, for a fixed distribution of the noise modifying information-carrying codewords, there is a maximum code rate computed as a mutual information quantity that no error correction code can surpass, provided that all errors induced by the noise distribution can be corrected with a probability approaching one.

Given an error correction code, there is thus a threshold error correction capability (such as the BER threshold) of the error correction code. Given such a threshold, there is a maximum code rate given by the Shannon capacity. This maximum code rate is usually higher than the code rate of the given error correction code, and the ratio of the latter to the former is the error correction efficiency conventionally denoted by β which is normally less than one, β<1.

QKD systems often produce keys only up to some distances, which are sometimes short for practical purposes. Increasing the reach has always been a goal of utmost importance and may be achieved by different means such as changing the protocol, reducing hardware noise or using better error correction codes. With many practical QKD systems, which are usually based on fiber optics, a positive key rate may reach up to 100 km. When field fibers are used in a less ideal situation (such as old fibers), the reach may be further reduced. A longer reach makes QKD more attractive to bigger markets and opens QKD to more application scenarios.

### SUMMARY

In view of the above, this disclosure aims to improve the conventional devices and methods for performing information reconciliation in QKD systems. An objective is to provide a device and a method that achieves better error correction in the sense of enabling higher reach. Another objective is to use an error correction code having a code rate that exceeds, or is close to exceeding, the Shannon capacity for the particular observed noise characteristic in the data, or that additionally or alternatively leaves errors in the corrected QKD data (after being applied) with a high probability.

These and other objectives are achieved by the solutions provided in the independent claims. Advantageous implementations are further defined in the dependent claims.

A first aspect of the disclosure provides a device for communication with a remote device to perform information reconciliation in a QKD system. The device is configured to obtain QKD data; divide the QKD data into a set of data blocks, where each data block of the set of data blocks of the device corresponds to a data block of the remote device; determine, based on a BER and/or a SNR, an error correction code; perform an error correction step; and perform an error detection step. The error correction code is configured such that a code rate of the error correction code is larger than a Shannon capacity for noise exhibited by the QKD data, and/or that the error correction code, after decoding the QKD data, leaves errors in corrected QKD data with a probability of at least 98%. The error correction step includes performing decoding on each data block of a first input set of data blocks based on the error correction code and based on remote error correction information, and generating a first output set of data blocks based on the decoding. The error detection step includes computing local error detection information on each data block of a second input set of data blocks, and generating a second output set of data blocks based on the local error detection information and based on remote error detection information. The error correction step and the error detection step are performed in any order. If the error correction step is performed before the error detections step, the first input set of data blocks includes the set of data blocks of the device and the second input set of data blocks comprises the first output set of data blocks. Alternatively, if the error detection step is performed before the error correction step, the second input set of data blocks comprises the set of data blocks of the device and the first input set of data blocks includes the second output set of data blocks.

By operating (or misusing) an error correction code above the Shannon capacity for the noise statistics exhibited in the QKD data, and using it to attempt to decode the data, there is a high probability that either the corresponding decoding fails to conclude or the decoded data contains leftover errors (i.e., uncorrected errors). The further error detection step, thus, allows to catch the uncorrected errors in the data blocks.

This provides the advantage that it may be possible to obtain a high code rate for the QKD data that may even be higher than the Shannon capacity for the noise characteristics exhibited in the data. This may further increase the reach of the QKD system.

The device of the first aspect may be (or may be incorporated in) the transmitting device and/or the receiving device in the QKD system. The device may comprise hardware and software. The hardware may comprise analog or digital circuitry, or both analog and digital circuitry. The digital circuitry may comprise components such as application-specific integrated circuits (ASICs), field-programmable arrays (FPGAs), digital signal processors (DSPs), or multi-purpose processors. In some embodiments, the device comprises one or more processors and a non-volatile memory connected to the one or more processors. The non-volatile memory may carry executable program code, which, when executed by the one or more processors, causes the device to perform the operations or methods described herein.

In an implementation form of the first aspect, the device, based on a predefined criterion, is further configured to perform the error correction step one or more times; and perform the error detection step one or more times. The error correction steps and the error detection steps are performed in any order. The respective input set of data blocks for the error correction steps and the error detection steps includes the output set of data blocks generated by a previous error correction step or error detection step.

Based on the result of an error detections step, i.e., whether an error in a data block is detected, the device may perform a further error detections step or may perform another error correction step. After performing this multi-step procedure, the probability that a data block of the device is identical to the corresponding data block of the remote device is increased.

In an implementation form of the first aspect, the device is further configured to receive the remote error correction information from the remote device, where the remote error correction information includes error correction information computed by the remote device on the corresponding data block of the remote device based on the error correction code.

In a further implementation form of the first aspect, generating the first output set of data blocks based on the decoding includes retaining the data block when the decoding is successful, discarding the data block when the decoding fails, and generating the first output set of data blocks based on the retained data blocks.

This exploits the characteristic of QKD that it is acceptable to give up on some data that the error correction code is unable to correct while working on the assumption that whether the decoding succeeds or not is not influenced by Eve.

In an implementation form of the first aspect, generating the first output set of data blocks based on the retained data blocks includes merging two or more retained data blocks, and generating the first output set of data blocks based on the merged data blocks.

This provides the advantage that the size of the data blocks may be flexibly modified in each step so that the code rate and the reach of the QKD system are optimized.

In an implementation form of the first aspect, the error correction code is specified by a parity-check matrix.

In an implementation form of the first aspect, the remote error correction information includes a syndrome, the syndrome being based on the parity-check matrix.

In an implementation form of the first aspect, the generation of the second output set of data blocks based on the local error detection information and based on remote error detection information includes receiving, from the remote device, the remote error detection information; retaining the data block when the local error detection information is equal to the remote error detection information; discarding the data block when the local error detection information is different from the remote error detection information; and generating the second output set of data blocks based on the retained data blocks. The remote error detection information includes error detection information computed by the remote device on the corresponding data block of the remote device. The local error detection information includes error detection information computed by the device on each data block of the input set of data blocks.

This exploits the characteristic of QKD that it is acceptable to give up on some data that the error correction code is unable to correct while working on the assumption that whether the decoding succeeds or not is not influenced by Eve.

In an implementation form of the first aspect, generating the second output set of data blocks based on the retained data blocks includes merging two or more retained data blocks; and generating the second output set of data blocks based on the merged data blocks.

This provides the advantage that the size of the data blocks may be flexibly modified in each step so that the code rate and the reach of the QKD system are optimized.

In an implementation form of the first aspect, the error detection information includes a hash value.

In an implementation form of the first aspect, the hash value includes a check value generated by a cyclic redundancy check (CRC).

In an implementation form of the first aspect, a total number of data blocks of the device is the same as a total number of data blocks of the remote device, and a size of each data block of the device is the same as a size of the corresponding data block of the remote device.

In an implementation form of the first aspect, the device is further configured to perform privacy amplification on a final output set of data blocks, where the final output set of data blocks includes the output set of data blocks generated by the last error correction step or the last error detection step after the predefined criterion is reached.

This enables to amplify away the publicly announced error correction information sent by the remote device to the device if a data block eventually forms part of a key.

A second aspect of the disclosure provides a method for a device for communication with a remote device for performing information reconciliation in a QKD system. The method includes obtaining QKD data; dividing the QKD data into a set of data blocks, where each data block of the set of data blocks of the device corresponds to a data block of the remote device; determining, based on a BER and/or a SNR, an error correction code; performing an error correction step; and performing an error detection step. The error correction code is configured such that a code rate of the error correction code is larger than a Shannon capacity for noise exhibited by the QKD data, and/or that the error correction code, after decoding the QKD data, leaves errors in corrected QKD data with a probability of at least 98%. The error correction step includes performing decoding on each data block of a first input set of data blocks based on the error correction code and based on remote error correction information, and generating a first output set of data blocks based on the decoding. The error detection step includes computing local error detection information on each data block of a second input set of data blocks, and generating a second output set of data blocks based on the local error detection information and based on remote error detection information. The error correction step and the error detection step are performed in any order. If the error correction step is performed before the error detections step, the first input set of data blocks includes the set of data blocks of the device and the second input set of data blocks includes the first output set of data blocks. Alternatively, if the error detection step is performed before the error correction step, the second input set of data blocks includes the set of data blocks of the device and the first input set of data blocks includes the second output set of data blocks.

In an implementation form of the second aspect, the method further includes performing the error correction step one or more times and performing the error detection step one or more times, based on a predefined criterion. The error correction steps and the error detection steps are performed in any order. The respective input set of data blocks for the error correction steps and the error detection steps includes the output set of data blocks generated by a previous error correction step or error detection step.

Based on the result of an error detections step, i.e., whether an error in a data block is detected, the device may perform a further error detections step or may perform another error correction step. After performing this multi-step procedure, the probability that a data block of the device is identical to the corresponding data block of the remote device is increased.

In an implementation form of the second aspect, the method further includes receiving the remote error correction information from the remote device, where the remote error correction information includes error correction information computed by the remote device on the corresponding data block of the remote device based on the error correction code.

In a further implementation form of the second aspect, generating the first output set of data blocks based on the decoding includes retaining the data block when the decoding is successful, discarding the data block when the decoding fails, and generating the first output set of data blocks based on the retained data blocks.

This exploits the characteristic of QKD that it is acceptable to give up on some data that the error correction code is unable to correct while working on the assumption that whether the decoding succeeds or not is not influenced by Eve.

In an implementation form of the second aspect, generating the first output set of data blocks based on the retained data blocks includes merging two or more retained data blocks, and generating the first output set of data blocks based on the merged data blocks.

This provides the advantage that the size of the data blocks may be flexibly modified in each step so that the code rate and the reach of the QKD system are optimized.

In an implementation form of the second aspect, the error correction code is specified by a parity-check matrix.

In an implementation form of the second aspect, the remote error correction information includes a syndrome, the syndrome being based on the parity-check matrix.

In an implementation form of the second aspect, generating the second output set of data blocks based on the local error detection information and based on remote error detection information includes: receiving, from the remote device, the remote error detection information; retaining the data block when the local error detection information is equal to the remote error detection information; discarding the data block when the local error detection information is different from the remote error detection information; and generating the second output set of data blocks based on the retained data blocks. The remote error detection information includes error detection information computed by the remote device on the corresponding data block of the remote device. The local error detection information includes error detection information computed by the device on each data block of the input set of data blocks.

This exploits the characteristic of QKD that it is acceptable to give up on some data that the error correction code is unable to correct while working on the assumption that whether the decoding succeeds or not is not influenced by Eve.

In an implementation form of the second aspect, generating the second output set of data blocks based on the retained data blocks includes merging two or more retained data blocks; and generating the second output set of data blocks based on the merged data blocks.

This provides the advantage that the size of the data blocks may be flexibly modified in each step so that the code rate and the reach of the QKD system are optimized.

In an implementation form of the second aspect, the error detection information includes a hash value.

In an implementation form of the second aspect, the hash value includes a check value generated by a CRC.

In an implementation form of the second aspect, a total number of data blocks of the device is the same as a total number of data blocks of the remote device, and a size of each data block of the device is the same as a size of the corresponding data block of the remote device.

In an implementation form of the second aspect, the method further includes performing privacy amplification on a final output set of data blocks, where the final output set of data blocks includes the output set of data blocks generated by the last error correction step or the last error detection step after the predefined criterion is reached.

This enables to amplify away the publicly announced error correction information sent by the remote device to the device if a data block eventually forms part of a key.

A third aspect of the disclosure provides a computer program comprising instructions which, when the program is executed by a computer, cause the computer to carry out the method according to the second aspect.

The method according to the second aspect and the computer program product according to the third aspect and their implementation forms provide the same advantages and effects as described above for the device of the first aspect and its respective implementation forms.

The main advantages of the solutions according to this disclosure, can be summarized as follows:
By using an error correction code that is tailored such that its code rate is larger than a Shannon capacity for the noise exhibited by the QKD data, and/or that it leaves errors in the corrected QKD data with a high probability (of at least 98%) as well as a multi-step scheme, an error correction efficiency β larger than one, β>1, can be obtained, which increases the reach of the QKD system.
The characteristic of QKD that it is acceptable to give up on some data that the error correction code is unable to correct is exploited, under the assumption that whether the decoding succeeds or not is not influenced by Eve.
The solutions according to this disclosure can be implemented for both forward reconciliation and reverse reconciliation. Moreover, the solutions according to this disclosure can be implemented in DV-QKD and CV-QKD.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms of the present disclosure will be explained in the following description of more specific embodiments in relation to the enclosed drawings, in which

FIG. 1 is a schematic view of a device for performing processing steps including information reconciliation in a QKD system, according to this disclosure;

FIG. 2 is an example for performing several error correction steps and several error detection steps in information reconciliation in a QKD system, according to this disclosure;

FIG. 3 is a flowchart of a method for performing an error correction step in reverse information reconciliation in a QKD system, according to this disclosure;

FIG. 4 is a flowchart of a method for performing an error correction step in forward information reconciliation in a QKD system, according to this disclosure;

FIG. 5 is a flowchart of a method for performing an error detection step in information reconciliation in a QKD system, according to this disclosure;

FIG. 6 is a schematic view of shows generating an output set of data blocks by performing error correction steps and error detection steps, according to this disclosure;

FIG. 7 is a flowchart of a method for performing information reconciliation in a QKD system, according to this disclosure;

FIG. 8 is a flowchart of a customary method for performing QKD.

### DETAILED DESCRIPTION OF EMBODIMENTS

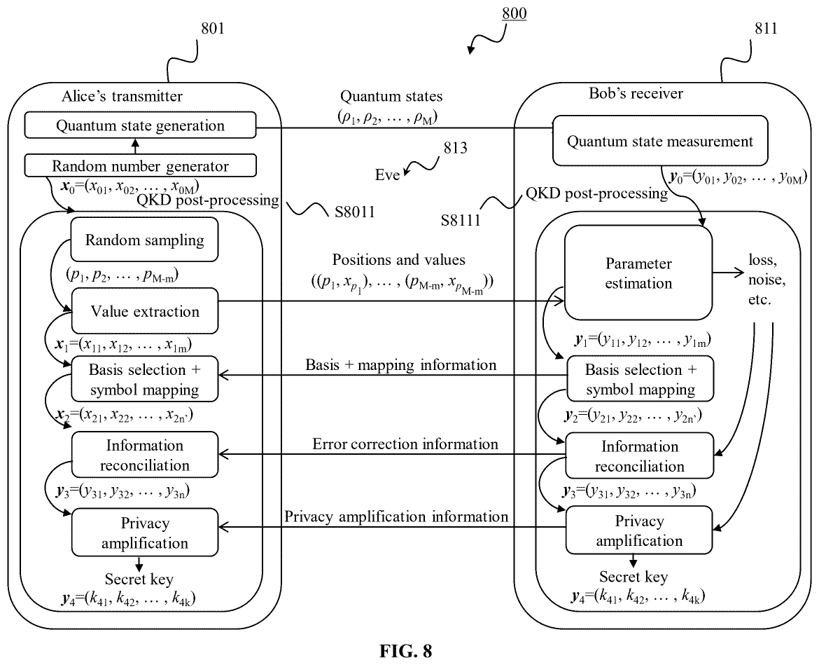

FIG. 8 is a flowchart of a conventional QKD protocol. A transmitting device 801 (corresponding to the user Alice) prepares a quantum state selected from a pre-agreed set. The quantum state is then transmitted to a receiving device 811 (corresponding to the user Bob), in the presence of an eavesdropper 813 (corresponding to Eve), over a quantum channel. Hereinafter, the terms “device” and “Alice” will be used interchangeably. Likewise, the terms “remote device” and “Bob” will be used interchangeably.

The receiving device 811 detects the received signal with a detection system which implements a quantum measurement. In DV-QKD, it is often the case that detection in the receiving device 811 is tuned to a random setting for each received signal and this setting corresponds to the quantum basis of the measurement. Since the setting is randomly chosen, the detected information may be completely uncorrelated with the state that the transmitting device 801 has sent (when the setting is chosen to be incompatible with Alice's state). These no-correlation cases are dropped in a sifting step later.

After transmission of the quantum state, the transmitting device 801 may perform QKD post-processing (step S8011 in FIG. 8) and the receiving device 811 may perform the QKD post-processing (i.e., step S8111 in FIG. 8) on classical computing devices connected by a classical error-free and authenticated channel in order to transform the raw data into a final secret key. It generally comprises a few main steps: parameter estimation, sifting (or basis selection), symbol mapping, information reconciliation, and privacy amplification.

In the parameter estimation step, Alice 801 and Bob 811 estimate the properties of the quantum channel which allow them to infer how much noise and loss there are in the raw key and how much information about the raw key has been leaked to Eve 813.

Then, in the sifting (or basis selection) step, which predominately exists in DV-QKD, Alice 801 and Bob 811 discard signal pairs where Bob 811 has used a setting incompatible with Alice's state.

In the symbol mapping step, which predominately exists in CV-QKD, Alice 801 and Bob 811 maps the possibly continuous-valued signal data into bit values (and soft information) for further processing.

In the information reconciliation step, Alice 801 and Bob 811 correct the differences in their keys to arrive at matching keys. Usually only one of them performs error correction on one's data to match the other's data.

In CV-QD, Alice 801 corrects her data to match Bobs' data and this is called reverse reconciliation, whereas forward reconciliation is where Bob 811 corrects his data to match Alice's.

Further, in the privacy amplification step, Alice 801 and Bob 811 perform a length-shortening operation that is specially designed to remove Eve's 813 information on the key. After this, Alice 801 and Bob 811 should get a final key secure against Eve 813.

In conventional QKD, as depicted in FIG. 8, either Alice's or Bob's key is regarded as correct, and the other party corrects his/her key to match this one. Moreover, Alice 801 and Bob 811 may use an error correction code, for example, based on the signal quality of the QKD data such as the SNR or BER.

The present disclosure is particularly related to the information reconciliation, for example and not at as a limitation, to the information reconciliation step that exists in physical-layer based classical key distribution.

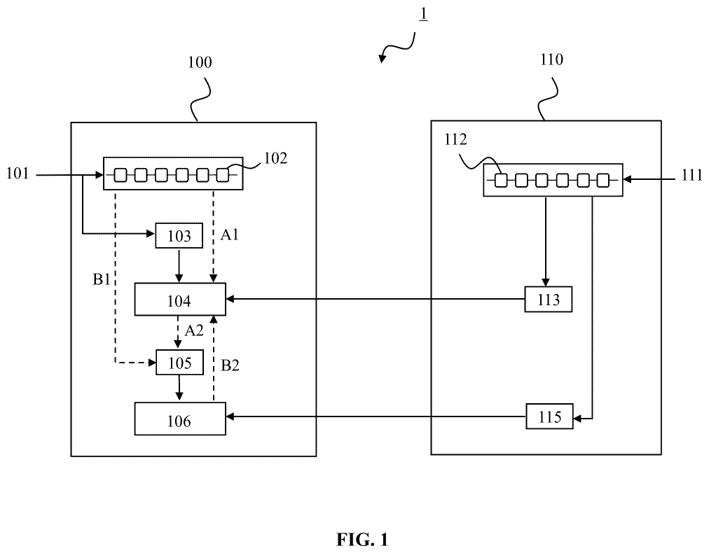

FIG. 1 is a schematic view of an exemplary embodiment of a device 100 for communication with a remote device 110 to perform information reconciliation in a QKD system 1, according to this disclosure.

The device 100 may be, or may be incorporated in, the transmitting device of the QKD system 1 and/or the receiving device. The device 110 may be, or may be incorporated in, the receiving device of the QKD system 1 and/or the transmitting device. Without limiting the present disclosure, in the following it is assumed that the device 100 is the transmitting device (Alice). Accordingly, the remote device 110 is the receiving device (Bob). In embodiments, one of device 110 and 100 is the transmitting device and the other the receiving device.

The device 100 or 110 may comprise processing circuitry (not shown) configured to perform, conduct or initiate the various operations of the device 100 or 110 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the device 100 or 110 to perform, conduct or initiate the operations or methods described herein.

The QKD system 1 may be a CV-QKD system or a DV-QKD system.

The device 100 is configured to obtain QKD data 101 and to divide the QKD data 101 into a set of data blocks 102. The remote device 110 may be configured to obtain its respective QKD data 111 and to divide the QKD data 111 into a set of data blocks 112 for the remote device 110.

The device 100 may divide the QKD data 101 randomly, e.g., the device 100 may arrange the QKD data 101 into the data blocks 102 randomly. The remote device 110 may also divide its QKD data 111 randomly, e.g., the remote device 110 may arrange the QKD data 111 into the data blocks 112 randomly. Thereby, each data block 102 of the device 100 corresponds to a data block 112 of the remote device 110, but they may be different in general.

The device 100 is then configured to determine, based on a BER and/or a SNR of the obtained QKD data 101, an error correction code 103. Notably, the error correction code 103 is configured such that a code rate of the error correction code is larger than a Shannon capacity for noise exhibited by the QKD data, and/or that the error correction code, after decoding the QKD data 101, leaves errors in corrected QKD data with a probability of at least 98%.

In this disclosure, an error refers to obtaining a data block of the device 100, after decoding the QKD data 101 with the error correction code 103, which is different from the corresponding data block of the remote device 110.

Then, the device 100 is configured to perform an error correction step. The error correction step comprises performing decoding on each data block of a first input set of data blocks based on the error correction code 103 and based on remote error correction information 113, and generating a first output set of data blocks 104 based on the decoding.

The remote error correction information 113 comprises error correction information computed by the remote device 110 on the corresponding data block 112 of the remote device based on the error correction code 103.

The remote device 110 may be configured to send the computed remote error correction information 113 to the device 100, and the device 100 is then further configured to receive the remote error correction information 113 from the remote device 110.

The device 100 is further configured to perform an error detection step. The error detection step comprises computing local error detection information 105 on each data block of a second input set of data blocks, and generating a second output set of data blocks 106 based on the local error detection information 105 and based on remote error detection information 115.

The remote error detection information 115 comprises error detection information computed by the remote device 110 on the corresponding data block 112 of the remote device 110.

Notably, the error correction step and the error detection step are performed by the device 100 in any order, e.g., may be performed in any interleaving manner.

When the error correction step is performed before the error detections step (alternative A, following the arrows A1 and A2 in FIG. 1), the first input set of data blocks comprises the set of data blocks 102 of the device 100 and the second input set of data blocks comprises the first output set of data blocks 104. That is, the decoding based on the error correction code 103 and based on remote error correction information 113 is performed in each data block 102 of the set of data blocks (A1) of the device 100, and the local error detection information 105 is computed on each data block of the first output set of data blocks 104 (A2) generated based on the decoding.

Alternatively (alternative B, following the arrows B1 and B2 in FIG. 1), when the error detection step is performed before the error correction step, the second input set of data blocks comprises the set of data blocks 102 of the device 100 and the first input set of data blocks comprises the second output set of data blocks 106. That is, the local error detection information 105 is computed on each data block of the set of data blocks 102 of the device 100 (B1), and the decoding based on the error correction code 103 and based on remote error correction information 113 is performed in each data block of the second output set of data blocks 106 (B2) generated based on the local error detection information 105 and based on remote error detection information 115.

The device 100 may be further configured to perform the correction step one or more times and to perform the error detection step one or more times, based on a predefined criterion. That is, the error correction step can be performed one or more times and/or the error detection step can be performed one or more times until the predefined criterion is satisfied.

The predefined criterion, for example and not as a limitation, may comprise that a total number of error correction steps is smaller than or equal to a predefined quantity. Additionally or alternatively, it may comprise that a total number of error detection steps is smaller than or equal to a predefined quantity. Further additionally or alternatively, the predefined criterion may comprise that a total number of error correction steps and a total number of error detection steps is smaller than or equal to a predefined quantity.

The error correction steps and the error detection steps are performed in any order, for example in any interleaving manner, and the respective input set of data blocks for each of the one or more error correction steps and for each of the one or more the error detection steps comprises the output set of data blocks 104, 106 generated by a previous error correction step or error detection step.

That is, each of the one or more error correction steps may generate a new first output set of data blocks 104 based on the decoding, and each of the one or more error correction steps may generate a new second output set of data blocks 106 based on the local error detection information 105 and based on remote error detection information 115. Thus, the respective input set of data blocks for each of the one or more error correction steps and for each of the one or more the error detection steps comprises the new first output set of data blocks 104 when the previous step is an error correction step, or the new second output set of data blocks 106 when the previous step is an error detection step.

For example and not as a limitation, the device 100 may be configured to perform an error correction step followed by one or more error detection steps. In a further example, the device 100 may be configured to perform an error detection step followed by one or more error corrections steps, and then one or more error detection steps can be further performed until the predefined criterion is reached.

In the exemplary embodiment of FIG. 1, the error correction code 103 may be, for example and not as a limitation, a linear error correction code 103. The linear correction code 103 may be specified by a parity-check matrix H, and the remote error correction information 113 may comprise a syndrome, the syndrome being based on the parity-check matrix H.

In this embodiment, the error detection information 105, 115, i.e., both the local error detection information 105 and the remote error detection information 115, comprise a hash value. The hash value comprises a check value generated by a CRC.

In the exemplary embodiment of FIG. 1, after the device 100 performs the decoding on each data block of the first input set of data blocks based on the error correction code 103 and based on remote error correction information 113, the generating the first output set of data blocks based on the decoding comprises the following steps. When the decoding of each data block of the first input set of data blocks is successful, the device 100 is configured to retaining the data block, additionally the device 100 is configured to discard the data block when the decoding fails.

Then, the device 100 is configured to generate the first output set of data blocks 104 based on the retained data blocks.

The generated first output set of data blocks 104 based on the retained data blocks may comprise only the retained data blocks.

The same procedure for generating the first output set of data blocks 104 may be implemented by the device 100 in each of the one or more error correction steps that are performed, if any.

The device 100 may be configured to send to the remote device 110 information indicating which of the data blocks 102 of the device 100 has been discarded in this step. The remote device 110, then, may accordingly discard its corresponding data block 112. Thereby, each data block 104 of the first output set of data blocks 104 of the device 100 may correspond to a data block of the remote device 110 after the remote device 110 generated its QKD data 111 based on the error correction code 103.

In this exemplary embodiment, after the device 100 computes the local error detection information 105 on each data block of the second input set of data blocks, the generation of the second output set of data blocks 106 based on the local error detection information 105 and based on remote error detection information 115 comprises the following steps.

The device 100 is configured to receive, from the remote device 110, the remote error detection information 115. The remote error detection information 115 comprises error detection information computed by the remote device 110 on the corresponding data block of the remote device 112.

Then, the device 100 may be configured to compare the remote error detection information 115 to the local error detection information 105.

Further, the device 100 is configured to retain the data block when the local error detection information 105 is equal to the remote error detection information 105, and when the local error detection information 105 is different from the remote error detection information, the device 100 is configured to discard data block.

Then, the device 100 is configured to generate the second output set of data blocks 106 based on the retained data blocks.

The generated second output set of data blocks 106 based on the retained data blocks may comprise only the retained data blocks.

The same procedure for generating the second output set of data blocks 106 may be implemented by the device 100 in each of the one or more error detection steps that are performed, if any.

The device 100 may be configured to send to the remote device 110 information indicating which of the data blocks 102 of the device 100 has been discarded in each of the one or more error detection steps. The remote device 110, then, may accordingly discard its corresponding data block. Thereby, each data block 106 of the second output set of data blocks 106 of the device 100 corresponds to a data block of the remote device 110 after the remote device 110 computed the remote error detection information 115.

Thereby, this disclosure may benefit from the characteristic of QKD that it is acceptable to give up on some data that the error correction code 103 is unable to correct while working on the assumption that whether the decoding succeeds or not is not influenced by Eve 103.

Notably, all the announced information in the performed error correction steps and error detection steps needs to be privacy amplified away.

Thus, the device 100 is configured to perform privacy amplification on a final output set of data blocks, wherein the final output set of data blocks comprises the output set of data blocks generated by the last error correction step or the last error detection step after the predefined criterion is reached.

Equivalently, a code rate may be computed for a group of data blocks that successfully pass all steps (i.e., that are retained in each of the performed error corrections steps and/or error detection steps) of the information reconciliation procedure, by taking a ratio between a first term and a total size of the blocks, where the first term is the total size of the blocks minus a size of the announced information corresponding to these blocks announced in all steps. Notably, this code rate may be higher than the Shannon capacity.

Either in classical communications or in QKD, it is customary to use error correction codes in a “normal way”, i.e., where the code rates are below the Shannon capacity for the particular noise characteristic exhibited by the QKD data in the form of the SNR and/or the BER. The standard application of error correction codes with the requirement of being able to correct all observed errors, is more suitable for communication of messages rather than for QKD, which is the communication of shared randomness. Thus, in QKD, not all the data needs to be corrected. It may be acceptable that some random data communicated between Alice and Bob do not end up being used in QKD, for example due to errors not corrected, since only the correct data (or corrected with a very high probability) by using the error correction code contribute to the final key.

Thus, in this disclosure, the error correction code 103 is purposely used in an “abnormal way”. That is, the error correction code 103 is tailored such that its code rate exceeds (or is close to exceeding) the Shannon capacity for the particular noise characteristic exhibited in the QKD data 101. Additionally or alternatively, the “abnormal” error correction code 103 is designed such that, after being used for coding QKD data, the error correction code 103 leaves errors in the corrected QKD data with a high probability, for example of the order of 98%.

Naturally, such an error correction is not likely to succeed. There is a high chance that either the decoding fails to conclude or the decoded data contains leftover errors (i.e., the uncorrected errors). However, the one or more error detection step performed by the device 100 enables to find out whether there are errors in the data, which can be further corrected by performing one or more error correction steps.

The advantages provided by the solutions according to this disclosure may be appreciated by examining the key generation rate formulas for QKD, given in equation (1) for forward reconciliation and equation (2) for reverse reconciliation:

$$Key generation rate per transmitted signal = {q}_{other} {q}_{IC} ( β I ( A : B ) - I ( E : A ) ) , \qquad ( 1 )$$

$$Key generation rate per transmitted signal = {q}_{other} {q}_{IC} ( β I ( A : B ) - I ( E : B ) ) , \qquad ( 2 )$$

where:
q_{IC}: is a factor due to not being able to correct all data in information reconciliation.
qₒₜₕₑᵣ: is factor due to other reasons such as training, synchronization.
β: is an error correction efficiency for the retained data.
I (A:B): is the mutual information between Alice and Bob.
I (E:A): is the mutual information between Eve and Alice (for the case of forward reconciliation).
I (E:B): is the mutual information between Eve and Bob (for the case of reverse reconciliation).

The code rate at Shannon capacity is given by the mutual information between Alice and Bob, I (A:B).

In conventional solutions, error correction codes are operated in a usual way and the error correction efficiency β is less than one, i.e., β<1.

In this disclosure, the “abnormal” error correction code 103 and the multi-step scheme can produce a code efficiency β larger than one, β>1, at the expense of reducing q_{IC}.

It should be noted that the reach of a QKD system corresponds to the distance at which the key rate is zero. Thus, increasing β results in increasing the reach.

Hence, this embodiment provides the advantage that it is possible to get a high code rate for the data that remains, and the code rate may even be higher than the Shannon capacity for the noise characteristics exhibited in the data.

Furthermore, the key generation rate in the QKD system 1 may be increased for certain distances and the reach of QKD may be increased.

In an embodiment, in each error correction step performed by the device 100, generating the first output set of data blocks 104 based on the retained data blocks may comprise merging two or more retained data blocks and generating the first output set of data blocks 104 based on the merged data blocks. Alternatively, generating the first output set of data blocks 104 based on the retained data blocks may comprise splitting one or more retained data blocks, and generating the first output set of data blocks 104 based on the split data blocks.

Additionally or alternatively, in each error detection step performed by the device 100, generating the second output set of data blocks 106 based on the retained data blocks comprises merging two or more retained data blocks, and generating the second output set of data blocks 106 based on the merged data blocks. Alternatively, generating the second output set of data blocks 106 based on the retained data blocks may comprise splitting one or more retained data blocks, and generating the second output set of data blocks 106 based on the split data blocks.

Notably, that the data blocks of the respective input set of data blocks of the one or more error correction steps and the one or more error detection steps may be merged or split to a size that is suitable for processing at each step. The size of the data blocks for each step and the parameters required for each step may be strategically chosen to optimize the code rate and the reach of the QKD system. For example, the sizes of data blocks may be in the order of 10 kbits or 1 Mbits.

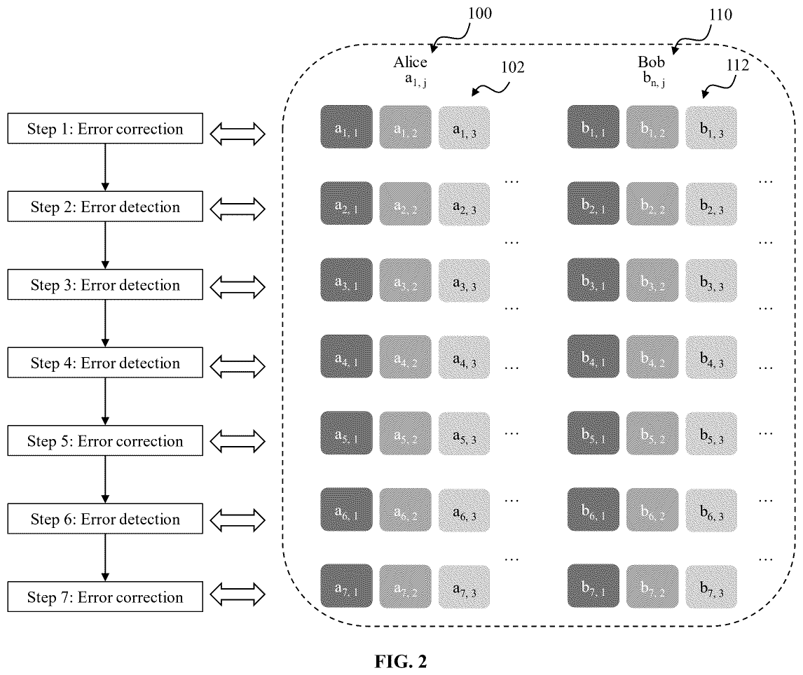

FIG. 2 depicts an example for performing several error correction steps and several error detection steps in information reconciliation in a QKD system 1, according to this disclosure. Same elements are labelled with the same reference signs.

In the example of FIG. 2, the QKD data 101 of the device 100 is divided into blocks a_{1,j}, and the QKD data 110 of the remote device 110 is divided into blocks and b_{1,j}. In this disclosure, the index j refers to an index of the block number, exemplary j=1, 2, 3 in FIG. 2.

Each input block to the first step may be transformed into an output block (i.e., a generated first output data block 104 or a generated second output set of data blocks 106), if any. The output blocks serve as inputs to a next step n. The blocks may be split or merged to generate new blocks a_{n,j} and b_{n,j}, as explained above in this disclosure, of suitable sizes, where j is the index of the new block number before actually being operated by the step n. The size of each data block a_{n,j} and b_{n,j}. may be operable by the step n, where the index n refers to the step performed, with n=1, 2, . . . , m and where m is a total number of steps. The total number of steps m may be determined based on the predefined criterion. Additionally or alternatively, the total number of steps m may be a predefined quantity.

It is to be mentioned that the color of the boxes representing the data blocks a_{n,j} and b_{n,j} in the different steps depicted in FIG. 2 do not imply that they are the same blocks.

Each step n may be an error correction step or an error detection step. In this example, the first step is an error correction step, and the first input set of data blocks 102 is the set of set of data blocks 102 of the remote device 110. The device 100 may then generate a first output set of data blocks 104 based on the decoding. The second step is an error detection step, in which the device 100 may be configured to compute local error detection information 105 on each data block of a second input set of data blocks. The second input set of data blocks in this example comprises the first set of data blocks 104 generated in the first (error correction) step.

The error detection step may catch errors in the data blocks. Based on the result of the error detection step (i.e., whether an error is detected in a data block), the device 100 may be configured to perform another error detection step as a third step. Additionally or alternatively, the device 100 may be configured to drop the block for further processing as explained above, or to perform another operation such as another error correction step. The device 100 may stop this procedure until the predefined criterion is satisfied.

In the example of FIG. 2, a further error detection step 4 followed by a fifth step that is an error correction step, is performed by the device 100. The input set of data blocks for each of the error detection steps 2 to 4 and for the error correction step 5 may comprise the output set of data blocks generated by the previous step. A further error detection step 6 followed by a seventh step error correction step, is performed by the device 100. The input set of data blocks for each of the error detection steps 2, 3, 4 and 6, and for the error correction steps 5 and 7 may comprise the output set of data blocks generated by the previous step.

The output set of data blocks of the final (or last) step may also be split or merged at the conclusion of the information reconciliation procedure.

Notably, the final set of data blocks data that successfully passes through all the steps, exemplary steps 1 to 7 in FIG. 2, may be tagged with an associated amount of information leaked in each step. Such information may be used in a later privacy amplification step to privacy amplify away the leaked information.

Thus, any of the error correction/detection steps, exemplary the steps 1 to 7 in FIG. 2, is just a part of the bigger procedure that performs information reconciliation, as disclosed above in relation with FIG. 8.

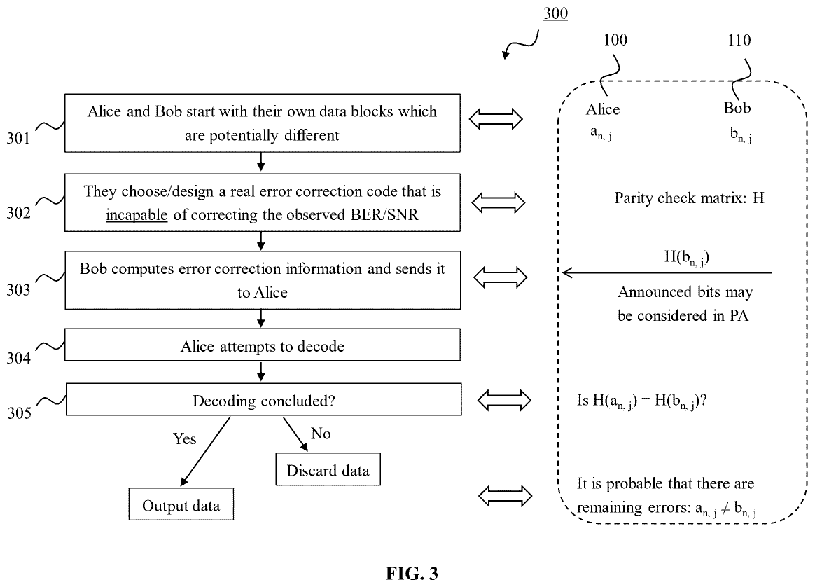

FIG. 3 shows an exemplary embodiment for a flowchart of a method 300 for performing an error correction step in reverse information reconciliation in a QKD system, according to this disclosure. Same elements are labelled with the same reference signs.

In 301, Alice (device) 100 and Bob (remote device) 110 start with their respective data blocks a_{n,j} and b_{n,j}, which correspond to each other but are generally different. The index n refers to the step number and the index j refers to the block number. The goal of this step is generally not to make a_{n,j} and b_{n,j} identical with high probability, as in standard error correction. Here, the goal is to increase the probability that a_{n,j} and b_{n,j} are identical.

After applying this error correction step, the probability that a_{n,j} and b_{n,j} are identical may still be low however improved (ideally). In some cases, when the error correction step is performed as a later part of the whole sequence of steps in information reconciliation, the goal may be more towards making a_{n,j} and b_{n,j} identical with high probability, i.e., a goal that is similar to that in standard error correction.

In 302, Alice 100 and Bob 110 determine the error correction code 103 based on the BER and/or the SNR. In the embodiment of FIG. 3, the error correction code 103 may be achieved by a linear error correction code specified by a parity-check matrix H. The error correction code 103 is incapable (or close to be so) of correcting the noise exhibited in the QKD data 101, whose statistics may be characterized by the BER or SNR. As explained above, the error correction code 103 is incapable in the sense that, after correction, there is still a large probability of errors and such a code 103 is likely to have a code rate larger than the Shannon capacity for the BER/SNR level.

Next, in 303, Bob 110 computes the remote error correction information 113 and sends it to Alice 100. In the case of the linear error correction code 103, Bob 110 may compute the remote error correction information 113 by computing the multiplication of the parity check matrix H and his data blocks 112, i.e., its syndrome, denoted as H(b_{n,j}) in FIG. 3.

The publicly announced remote error correction information 113 sent by Bob 110 to Alice 100 may be considered in a further privacy amplification step to be amplified away if the data block eventually forms part of a QKD key.

In 304, Alice 100 attempts to decode each of her data blocks 102 using the syndrome received from Bob.

Next, in 305, Alice 100 determines whether the decoding concluded. If the decoding does not conclude with Alice's syndrome and Bob's syndrome being equal, the data block may be discarded. If the decoding does conclude, then the data block may be retained, and Alice 100 may generate the first output set of data blocks 104.

When the decoding successfully concludes, it is probable that there are remaining errors after the performed error correction step, particularly when the current error correction step is performed at the beginning of the whole information reconciliation procedure.

The method 300 can be also applied when the error correction step is performed one or more times.

Further, the error correction step as disclosed in the method 300 holds for a continuous data case with soft information decoding. For example, in the case of continuous data case with soft information, the continuous data may be discretized to form the initial data a_{n,j} and b_{n,j}, and the soft information for decoding may be extracted from the continuous data as probabilities of how likely particular units of data in a_{n,j} and b_{n,j} are the same.

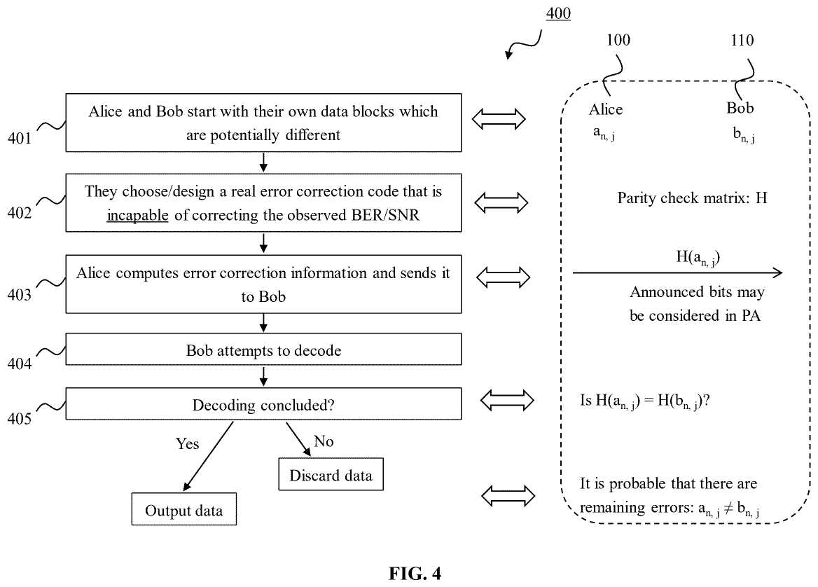

FIG. 4 shows an exemplary embodiment for a flowchart of a method 400 for performing an error correction step in forward information reconciliation in a QKD system 1, according to this disclosure. Same elements are labelled with the same reference signs.

The forward reconciliation case of FIG. 4 is similar to the reverse reconciliation case of FIG. 3 except that the roles of Alice 100 and Bob 110 are reversed.

The steps 401 and 402 are equivalent to the steps 301 and 302, respectively, explained above and therefore are not repeated here.

In 403, Alice 100 may compute local error correction information and sends it to Bob 110. The local error correction information may comprise error correction information computed by the device 110 on each data block 102 of the device 100 based on the error correction code 103.

In the case of the linear error correction code 103, Alice 100 may compute the local error correction information by computing the multiplication of the parity check matrix H and each of her data blocks 102, i.e., her syndrome, denoted as H(a_{n,j}) in FIG. 4, and may send it to Bob 110.

The publicly announced local error correction information sent by Alice 100 to Bob 110 may be considered in a further privacy amplification step to be amplified away if the data block eventually forms part of a QKD key.

In 404, Bob 110 may attempt to decode his data blocks 112 using the syndrome received from Alice 100.

Next, in 405, Bob 110 may determine whether the decoding concluded. If the decoding does not conclude with Alice's syndrome and Bob's syndrome being equal, the data block may be discarded. If the decoding does conclude, then the data block may be retained, and Bob 110 may generate a first output set of data blocks.

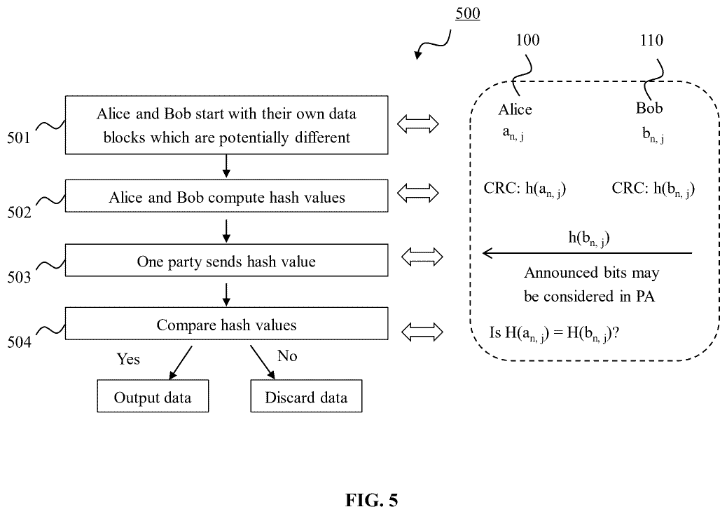

FIG. 5 shows an exemplary embodiment for a flowchart of a method 500 for performing an error detection step in information reconciliation in the QKD system 1, according to this disclosure. Same elements are labelled with the same reference signs.

In 501, Alice 100 and Bob 110 start with their respective data blocks a_{n,j} and b_{n,j}, which correspond to each other but are generally different. The index n refers to the step number and the index j refers to the block number.

The goal of this step is not to modify the data but to try to identify whether Alice's and Bob's data blocks are different. Both Alice 100 and Bob 110 may employ a hash-based detection scheme such as the CRC.

In 502, both Alice 100 and Bob 110 may compute the hash value of their respective first input data blocks, exemplary data blocks 102 and 112 when the error detection step is the first step, based on the determined CRC. The local CRC computed by Alice 100 is denoted h(a_{n,j}), and the remote CRC computed by Bob 100 is denoted h(b_{n,j}), as depicted in FIG. 5.

In 503, one party (in this embodiment Bob 110) sends his hash value to the other party (i.e., Alice 100).

Then, in 504, the other party (i.e., Alice 100) makes a comparison between the two hash values. If the hash values are different, the data blocks of Alice 100 and Bob 110 corresponding to each other are discarded. If the hash values are the same, the data blocks pass the current error detection step and are retained, generating the second output set of data blocks 106. The second output set of data blocks 106 may be used as an input for a next step, additionally or alternatively for another processing phase in the QKD procedure.

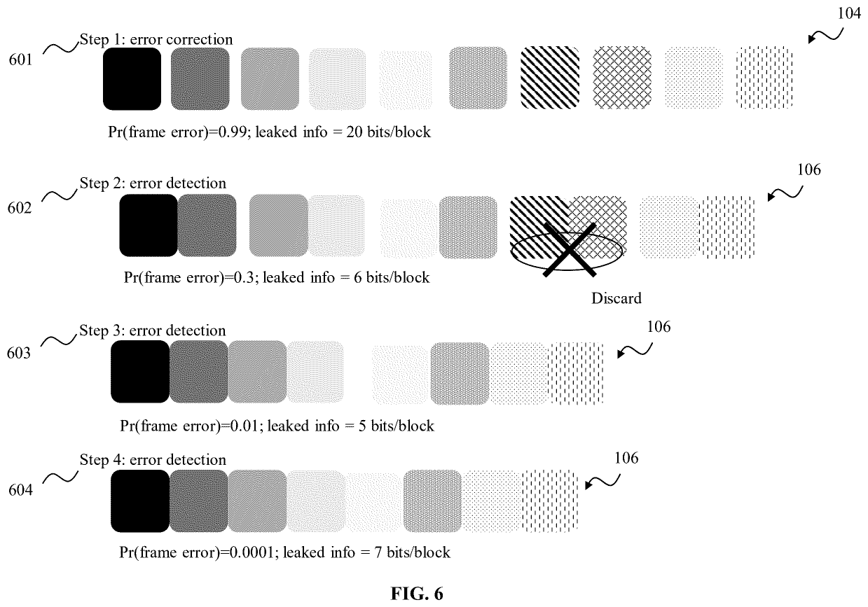

FIG. 6 shows a schematic view of generating an output set of data blocks by performing error correction steps and error detection steps, according to this disclosure. Same elements are labelled with the same reference signs.

The example of FIG. 6 illustrates a case where one error correction step followed by three error detection steps are performed. Data blocks at different steps may have different sizes. In each step, each data block of the device 100 corresponds to a data block of the remote device 112.

In 601, the first error correction step is performed and the exemplary 10 blocks shown in FIG. 6 successfully pass this step. That is, the decoding performed by the device 100 is successful for the 10 exemplary data blocks. Then, two blocks are merged to form a new block for the next step. The resulting five data blocks, each of which is formed by two data blocks after decoding, determine the first output set of data blocks 104 generated by the error correction step.

In the second step 602, which is an error detection step, one of the five data blocks is detected to be erroneous and is discarded (i.e., Alice's data block and the corresponding Bob's data block are dropped). Then two data blocks of step 2 that are not discarded are merged and the resulting two merged data blocks generate the second output data block 106, which in turn becomes the input data block for the next step.

In the third step 603, which is an error detection step, the two data blocks shown in FIG. 6 pass the error detection step. That is, no error are detected in these data blocks. Then, two blocks of step 3 are merged, forming a single output data block 106 that is used as an input for the next step.

In 604, the (single) data block passes the step 4, which is an error detection step.

In FIG. 6, some exemplary values for the probability of error in each step as well as an amount of leaked information for the data blocks that are retained at each step, are shown. It can be observed in FIG. 6 that the probability of error reduces as the data moves through the steps, which is desirable.

Further, all the announced information corresponding to the retained data blocks at the end of the sequence of steps performed may need to be privacy amplified away. In this example, one may consider the total leaked information for the last block to be 1*7+2*5+4*6+8*20=201 bits, which may be privacy amplified away.

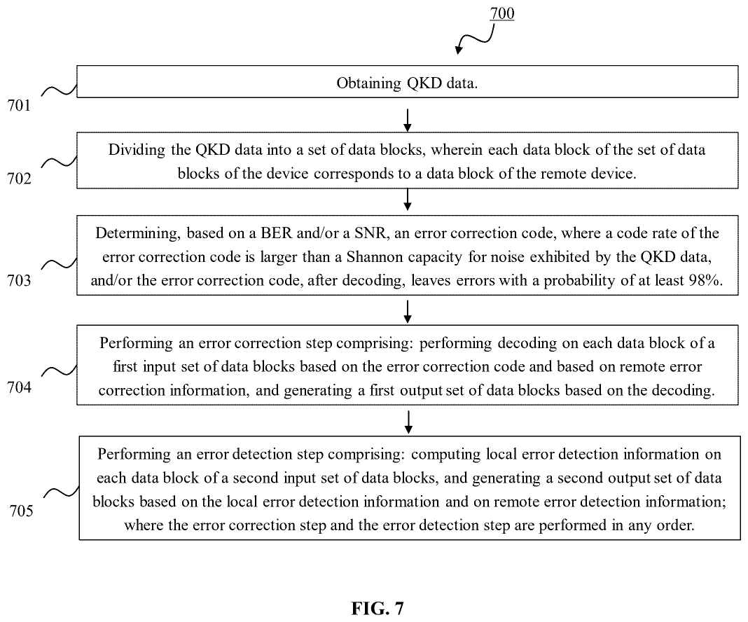

FIG. 7 shows an exemplary embodiment of a method 700 for a device 100 for communication with a remote device 110 for performing information reconciliation in a QKD system 1. The method 700 may be carried out by the device 100 (and/or the device 110), as it described above in this disclosure.

The method 700 comprises a step 701 of obtaining QKD data 101.

Then, the method 700 comprises a step 702 of dividing the QKD data 101 into a set of data blocks 102. Each data block of the set of data blocks 102 of the device 100 corresponds to a data block 112 of the remote device 110.

The method 700 further comprises a step 703 of determining, based on a BER and/or a SNR, an error correction code 103. The error correction code 103 is configured such that a code rate of the error correction code 103 is larger than a Shannon capacity for noise exhibited by the QKD data 101, and/or that the error correction code 103, after decoding the QKD data 101, leaves errors in corrected QKD data with a probability of at least 98%.

Further, the method 700 comprises a step 704 of performing an error correction step. The error correction step comprises performing decoding on each data block of a first input set of data blocks based on the error correction code 103 and based on remote error correction information 113, and generating a first output set of data blocks 104 based on the decoding.

The method 700 further comprises a step 705 of performing an error detection step, comprising computing local error detection information 105 on each data block of a second input set of data blocks, and generating a second output set of data blocks 106 based on the local error detection information 105 and based on remote error detection information 105.

Notably, the error correction step 704 and the error detection step 705 are performed in any order. If the error correction step 704 is performed before the error detections step 705, the first input set of data blocks comprises the set of data blocks 102 of the device and the second input set of data blocks comprises the first output set of data blocks 104. Alternatively, if the error detection step 705 is performed before the error correction step 704, the second input set of data blocks comprises the set of data blocks of the device 102 and the first input set of data blocks comprises the second output set of data blocks 106.

The method 700 may further comprise actions according to the described aforementioned embodiments of the device 100. Hence, the method 700 achieves the same advantages as the device 100.

The present disclosure further provides a computer program comprising instructions that, when the program is executed by a computer, cause the computer to carry out the method 700 shown in FIG. 7.

The computer program may be included in a computer readable medium. The computer readable medium may comprise essentially any memory, such as a ROM (Read-Only Memory), a PROM (Programmable Read-Only Memory), a 15 EPROM (Erasable PROM), a Flash memory, an EEPROM (Electrically Erasable PROM), or a hard disk drive.

The computer program achieves the same advantages as the method 700 and as the device 100.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A device, comprising:
at least one processor; and
a memory coupled to the at least one processor with instructions stored thereon, wherein the instructions, when executed by the at least one processor, enable the device to:
obtain Quantum Key Distribution (QKD) data,
divide the QKD data into a set of data blocks, wherein each data block of the set of data blocks of the device corresponds to a data block of a remote device,
determine, based on a Bit Error Rate (BER) or a Signal to Noise Ratio (SNR), an error correction code, wherein the error correction code is configured such that a code rate of the error correction code is larger than a Shannon capacity for noise exhibited by the QKD data, or that the error correction code, after decoding the QKD data, leaves errors in corrected QKD data with a probability of at least 98%,
perform an error correction step, comprising:
performing decoding on each data block of a first input set of data blocks based on the error correction code and based on remote error correction information, and
generating a first output set of data blocks based on the decoding, and
perform an error detection step, comprising:
computing local error detection information on each data block of a second input set of data blocks, and
generating a second output set of data blocks based on the local error detection information and based on remote error detection information, wherein
the error correction step and the error detection step are performed in any order, and
in response to the error correction step being performed before the error detection step, the first input set of data blocks comprises the set of data blocks of the device and the second input set of data blocks comprises the first output set of data blocks, and
in response to the error detection step being performed before the error correction step, the second input set of data blocks comprises the set of data blocks of the device and the first input set of data blocks comprises the second output set of data blocks.

2. The device according to claim 1, wherein the instructions, when executed by the at least one processor, further enable the device to:
perform the error correction step one or more times; and
perform the error detection step one or more times, wherein
the error correction step(s) and the error detection step(s) are performed in any order, and
the respective input set of data blocks for the error correction steps and the error detection step(s) comprises the output set of data blocks generated by a previous error correction step or error detection step.

3. The device according to claim 2, wherein the instructions, when executed by the at least one processor, further enable the device to:
perform privacy amplification on a final output set of data blocks, wherein the final output set of data blocks comprises the output set of data blocks generated by a last error correction step or a last error detection step after a predefined criterion is reached.

4. The device according to claim 1, wherein the instructions, when executed by the at least one processor, further enable the device to receive the remote error correction information from the remote device, wherein the remote error correction information comprises error correction information computed by the remote device on the corresponding data block of the remote device based on the error correction code.

5. The device according to claim 1, wherein the instructions, when executed by the at least one processor, enable the device to generate the first output set of data blocks based on the decoding by:
retaining a decoded data block of the first input set of data blocks in response to the decoding being successful;
discarding a data block of the first input set of data blocks in response to the decoding failing; and
generating the first output set of data blocks based on the retained data blocks.

6. The device according to claim 5, wherein the instructions, when executed by the at least one processor, enable the device to generate the first output set of data blocks based on the retained data blocks by:
merging two or more retained data blocks; and
generating the first output set of data blocks based on the merged data blocks.

7. The device according to claim 1, wherein the error correction code is specified by a parity-check matrix.

8. The device according to claim 7, wherein the remote error correction information comprises a syndrome, the syndrome being based on the parity-check matrix.

9. The device according to claim 1, wherein the instructions, when executed by the at least one processor, enable the device to generate the second output set of data blocks based on the local error detection information and based on remote error detection information by:
receiving, from the remote device, the remote error detection information, wherein the remote error detection information comprises error detection information computed by the remote device on the corresponding data block of the remote device;
retaining a data block of the second input set of data blocks in response to the local error detection information being equal to the remote error detection information, wherein the local error detection information comprises error detection information computed by the device on each data block of the input set of data blocks;
discarding the data block in response to the local error detection information being different from the remote error detection information; and
generating the second output set of data blocks based on the retained data blocks.

10. The device according to claim 9, wherein the instructions, when executed by the at least one processor, enable the device to generate the second output set of data blocks based on the retained data blocks by:
merging two or more retained data blocks; and
generating the second output set of data blocks based on the merged data blocks.

11. The device according to claim 1, wherein the local error detection information comprises a hash value.

12. The device according to claim 11, wherein the hash value comprises a check value generated by a cyclic redundancy check (CRC).

13. The device according to claim 1, wherein a total number of data blocks of the device is the same as a total number of data blocks of the remote device, and a size of each data block of the device is the same as a size of the corresponding data block of the remote device.

14. A method applied to a device, the method comprising:
obtaining Quantum Key Distribution (QKD) data;
dividing the QKD data into a set of data blocks, wherein each data block of the set of data blocks of the device corresponds to a data block of a remote device;
determining, based on a Bit Error Rate (BER) or a Signal to Noise Ratio (SNR), an error correction code, wherein the error correction code is configured such that a code rate of the error correction code is larger than a Shannon capacity for noise exhibited by the QKD data, or that the error correction code, after decoding the QKD data, leaves errors in corrected QKD data with a probability of at least 98%;
performing an error correction step, comprising:
performing decoding on each data block of a first input set of data blocks based on the error correction code and based on remote error correction information, and
generating a first output set of data blocks based on the decoding; and
performing an error detection step, comprising:
computing local error detection information on each data block of a second input set of data blocks, and
generating a second output set of data blocks based on the local error detection information and based on remote error detection information, wherein
the error correction step and the error detection step are performed in any order,
in response to the error correction step being performed before the error detection step, the first input set of data blocks comprises the set of data blocks of the device and the second input set of data blocks comprises the first output set of data blocks, and
in response to the error detection step being performed before the error correction step, the second input set of data blocks comprises the set of data blocks of the device and the first input set of data blocks comprises the second output set of data blocks.

15. The method according to claim 14, further comprising:
performing the error correction step one or more times; and
performing the error detection step one or more times, wherein
the error correction step(s) and the error detection step(s) are performed in any order, and
the respective input set of data blocks for the error correction steps and the error detection steps comprises the output set of data blocks generated by a previous error correction step or error detection step.

16. The method according to claim 14, further comprising:
receiving the remote error correction information from the remote device, wherein the remote error correction information comprises error correction information computed by the remote device on the corresponding data block of the remote device based on the error correction code.

17. The method according to claim 14, wherein generating the first output set of data blocks based on the decoding comprises:
retaining a decoded data block of the first input set of data blocks in response to the decoding being successful;
discarding a data block of the first input set of data blocks in response to the decoding failing; and
generating the first output set of data blocks based on the retained data blocks.

18. The method according to claim 17, wherein generating the first output set of data blocks based on the retained data blocks comprises:
merging two or more retained data blocks; and
generating the first output set of data blocks based on the merged data blocks.

19. The method according to claim 14, wherein the error correction code is specified by a parity-check matrix.

20. The method according to claim 19, wherein the remote error correction information comprises a syndrome, the syndrome being based on the parity-check matrix.
